(19) United States
(12) Patent Application Publication
(10) Pub. No.: US 2019/0081419 A1
(43) Pub. Date: Mar. 14, 2019

(54) ROTATABLE CONNECTOR ASSEMBLY

(71) Applicant: 3M INNOVATIVE PROPERTIES COMPANY, St. Paul, MN (US)

(72) Inventors: Shuo-Hsuan Hsieh, Kaohsiung City (TW); Hsin-Hsu Lin, Taoyuan City (TW)

(21) Appl. No.: 16/085,150

(22) PCT Filed: Feb. 22, 2017
(86) PCT No.: PCT/US2017/018800

§ 371 Date: Sep. 14, 2018

Related U.S. Application Data
(60) Provisional application No. 62/308,403, filed on Mar. 15, 2016.

(51) Int. Cl. H01R 12/52; H01R 35/02; H01R 12/72; H01R 13/66; H01R 13/629; H01R 13/506

(52) U.S. Cl. CPC H01R 12/52; H01R 35/02; H01R 13/506; H01R 13/665; H01R 13/629; H01R 12/721

(57) ABSTRACT

A connector assembly includes a connector that includes a front circuit board disposed within a front housing portion, and a rear circuit board disposed within a rear housing portion assembled to the front housing portion. Flexible electrically conductive traces provide electrical communication between the front and rear circuit boards. The rear housing portion is rotatable about a rotational axis relative to the front housing portion to change a relative orientation of the front and rear circuit boards and provide various cable exit types.

### FIELD

The disclosure relates to connectors or connector assemblies and, in particular, to connectors that include rotatable portions capable of changing a relative orientation.

### BACKGROUND

High-speed signal protocols such as, e.g., MiniSAS HD, etc. are often used for a number of applications. For example, high-speed protocols are often used for data communication between various electronic apparatus such as storage devices in computers. Due to the space limits and cable routing requests, connector assemblies for high-speed protocols may adopt a variety of cable exit types to meet the respective chassis design.

### BRIEF SUMMARY

Briefly, in one aspect, the present disclosure describes a connector that includes a first front circuit board disposed within a front housing portion, and a first rear circuit board disposed within a rear housing portion assembled to the front housing portion. Each of the first front and rear circuit boards includes a plurality of front contact pads disposed near a front edge of the circuit board, and a plurality of rear contact pads disposed behind and in electrical communication with the front contact pads. The front contact pads of the first front circuit board are configured to engage corresponding terminals of a mating connector. The rear contact pads of the first rear circuit board are configured to make electrical contact with conductors of a cable. A first plurality of flexible electrically conductive traces provide electrical communication between the rear contact pads of the first front circuit board and the front contact pads of the first rear circuit board. The rear housing portion is rotatable about a rotational axis relative to the front housing portion to change a relative orientation of the first front and rear circuit boards.

In another aspect, the present disclosure describes a connector assembly that includes a cable including a plurality of conductors, and a connector that includes a first front circuit board disposed within a front housing portion, and a first rear circuit board disposed within a rear housing portion assembled to the front housing portion. Each of the first front and rear circuit boards includes a plurality of front contact pads disposed near a front edge of the circuit board, and a plurality of rear contact pads disposed behind and in electrical communication with the front contact pads. The front contact pads of the first front circuit board are configured to engage corresponding terminals of a mating connector. The rear contact pads of the first rear circuit board are configured to make electrical contact with conductors of a cable. A first plurality of flexible electrically conductive traces provide electrical communication between the rear contact pads of the first front circuit board and the front contact pads of the first rear circuit board. The rear housing portion is rotatable about a rotational axis relative to the front housing portion to change a relative orientation of the first front and rear circuit boards. The plurality of conductors of the cable make electrical contact with the plurality of rear contact pads of the first rear circuit board.

In yet another aspect, the present disclosure describes a connector for mating with a mating connector along a mating direction. The connector includes a plurality of front terminals for making electrical contact with a corresponding plurality of terminals of a mating connector, and a plurality of rear terminals for making electrical contact with conductors of a cable received within the connector. The rear terminals is rotatable relative to the front terminals about a rotational axis substantially parallel to the mating direction.

Various advantages are obtained in exemplary embodiments of the disclosure. One such advantage of exemplary embodiments of the present disclosure is that the connectors can provide a variety of cable exit types by simple rotations without changing a component of the connectors.

The details of one or more embodiments of the present disclosure are set forth in the accompanying drawings and the description below. Other features, objects, and advantages of the present disclosure will be apparent from the description and drawings, and from the claims.

### BRIEF DESCRIPTION OF THE DRAWINGS

The disclosure may be more completely understood in consideration of the following detailed description of various embodiments of the disclosure in connection with the accompanying drawings, in which:

FIG. 1 is a perspective view of a connector assembly, according to one embodiment.

FIG. 2 is an exploded perspective view of the connector assembly of FIG. 1.

FIG. 3 is a side cross-sectional view of flexibly connected circuit boards of the connector assembly of FIGS. 1 and 2.

FIG. 4 is a perspective end view of a shielded cable for use with the rear circuit board of FIG. 3.

FIG. 5A is a side cross-sectional view of the connector assembly of FIG. 1 in a first orientation.

FIG. 5B is a side cross-sectional view of the connector assembly of FIG. 1 in a second orientation.

FIG. 5C is a side cross-sectional view of the connector assembly of FIG. 1 in a third orientation.

### DETAILED DESCRIPTION

In the following detailed description, reference is made to the accompanying drawings that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

The present disclosure relates to connectors or connector assemblies and, in particular, to connectors or connector assemblies that includes a front circuit board disposed within a front housing portion, and a rear circuit board disposed within a rear housing portion assembled to the front housing portion. Flexible electrically conductive traces provide electrical communication between the front and rear circuit boards. The rear housing portion is rotatable about a rotational axis relative to the front housing portion to change a relative orientation of the front and rear circuit boards.

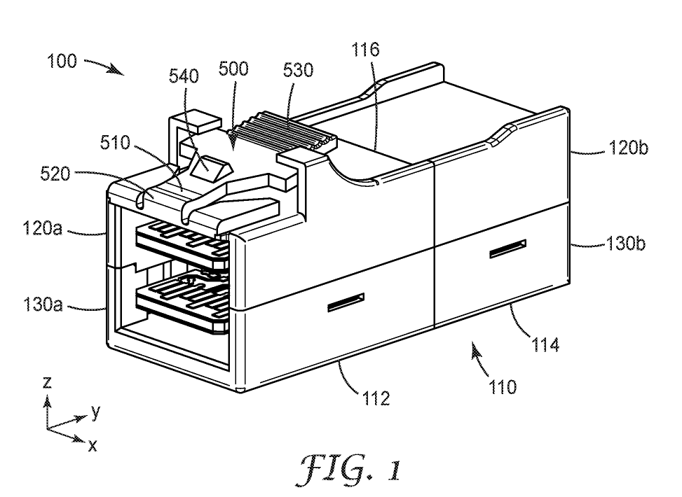

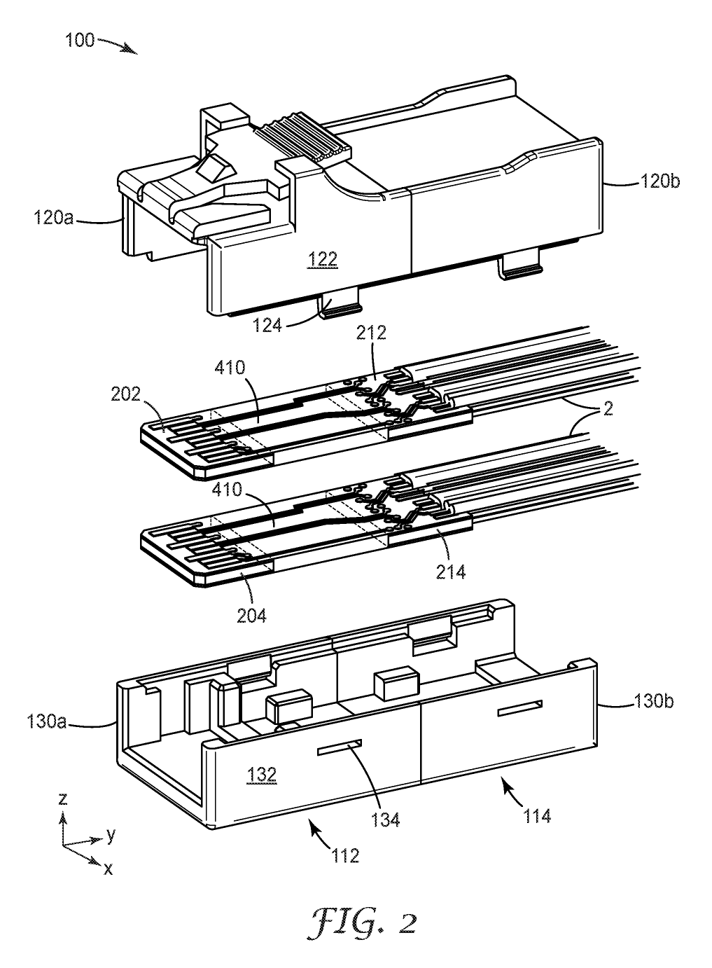

FIG. 1 is a perspective view of a connector assembly 100 and FIG. 2 is an exploded perspective view of the connector assembly 100 of FIG. 1. The connector assembly 100 includes a housing 110 having a front housing portion 112 and a rear housing portion 114. The housing 110 may be configured to insulate and securely position, or hold, one or more components of the connector assembly 100 at least partially or entirely located within the housing 110. The housing 110 may include electrically insulative, or dielectric, material, and thus, be referred to as an “insulative” housing. The insulative material of the housing 110 may include, for example, any suitable polymeric material.

The front and rear housing portions 112 and 114 are rotatably connected at a junction 116. The front housing portion 112 is configured to be rotatable with respect to the rear housing portion 114 about a rotational axis substantially parallel to the y-axis.

In the depicted embodiment, the front and rear housing portions 112 and 114 respectively include an upper housing half, or portion, 120a or 120b and a lower housing half, or portion 130a or 130b. The respective upper and lower housing halves may be coupled, or attached, to one another. In other words, the upper housing half 120a may be coupled, or attached, to the lower housing half 130a, and vice versa. The upper housing half 120b may be coupled, or attached, to the lower housing half 130b, and vice versa. While each of the upper and lower housing halves 120a-b, 130a-b are described herein as being “halves,” it is to be understood that each of the upper and lower housing halves may not be substantially “half” of the respective housing portions 112 and 114.

Additionally, the upper housing halves and the respective lower housing halves may be described as being removably coupled to one another. As used herein, “removably coupled” may be defined as a coupling between two elements, or objects, that may remain coupled to one another upon the application of normal operating forces and may be uncoupled, or removed from being coupled, by the application of a selected amount of force (e.g., greater than the normal operating forces) in one or more selected, or particular, directions. For example, after a user couples (e.g., snaps together) the upper housing half 120a or 120b and the lower housing half 130a or 130b, the upper housing halves and the lower housing halves may remain coupled together during normal operation until a user may decide to uncouple the upper housing halves from the lower housing halves. In some embodiments, it is to be understood that the coupling and de-coupling of the housing halves 120a and 130a, and 120b and 130b may be independent from each other. Further, each of the upper and lower housing halves may be insulative, and thus, be referred to as insulative housing halves.

The upper housing halves and the lower housing halves may be coupled together, or assembled, using any suitable mechanisms including, for example, snap fit, friction fit, press fit, mechanical clamping, etc. Additionally, many different structures such as, e.g., latches, openings, protrusions, etc., may be used to provide the coupling between the upper housing halves and the lower housing halves. As shown in FIG. 2, a side wall 132 of the lower housing half 130a may define at least one (e.g., one or more, a plurality, only one, etc.) opening 134 therethrough (or partially therein) and a corresponding side wall 122 (e.g., corresponding to the side wall 132 of the lower housing half 130a) of the upper housing half 120a may define at least one latch 124. The at least one opening 134 and the at least one latch 124 are configured to engage with each other (e.g., snap-fit to each other) to assemble, or couple, the lower housing half 130a to the upper housing half 120a. For example, the upper housing half 120a may be removably assembled to the lower housing half 130a by the at least one opening 134 receiving and engaging the at least one latch 124. The at least one latch 124 may extend within the at least one opening 134. In the depicted embodiment, the housing 110 includes four latches 124 at the upper housing halves, and four openings 134 located at the lower housing halves. It is to be understood that other numbers of mating latches and openings can be used.

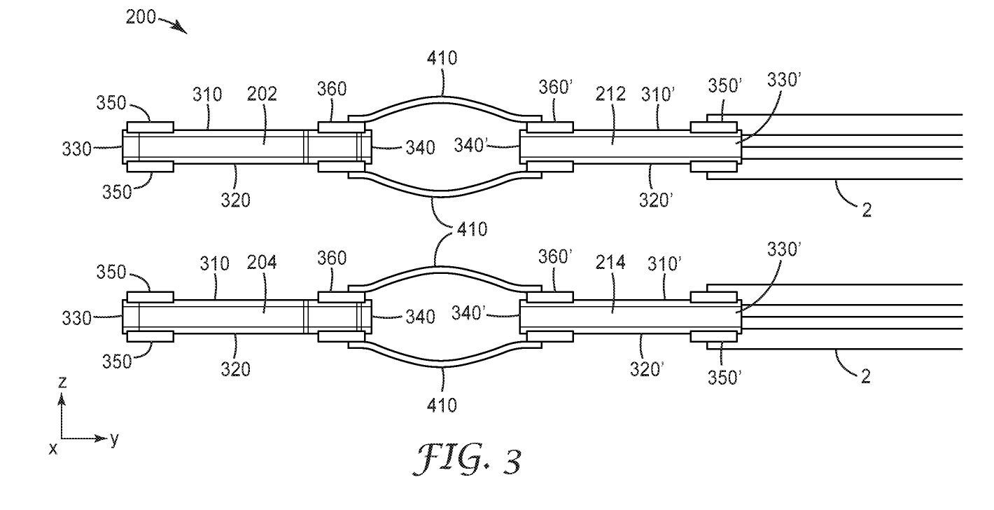

The connector assembly 100 further includes a first front circuit board 202 and a second front circuit board 204 that can be disposed within the front housing portion 112, and a first rear circuit board 212 and a second rear circuit board 214 that can be disposed within the rear housing portion 114. FIG. 2 illustrates a side perspective view in exploded form of the connector assembly 100. FIG. 3 illustrates a cross-sectional view of the circuit boards 202, 212, 204 and 214. It is to be understood that one or more front circuit boards (e.g., 202 or 204) can be disposed within the front housing portion 112, and one or more rear circuit boards (e.g., 212 or 214) can be disposed within the rear housing portion 114.

Various numbers of circuit boards can be attached to the housing 110 via any suitable mechanisms. In some embodiments, each of the circuit boards may include one or more notches (not shown) that can engage a vertical protrusion of the housing 110 to position the circuit boards within the housing 110.

Each of the front or rear circuit boards 202, 204, 212 or 214 can include front contact pads disposed near a front edge of the respective circuit board, and rear contact pads disposed behind and in electrical communication with the front contact pads. More specifically, in the depicted embodiment shown in FIG. 3, electrically conductive front contact pads 350 are disposed on one or both of the upper and lower surfaces 310, 320 at the mating end 330 of the front circuit board 202 or 204. The electrically conductive contact pads 350 are configured to engage terminals of a mating connector (not shown). In some embodiments, the mating connector is coupled to the connector assembly 100 along a mating direction (e.g., substantially parallel to the y-axis). Further, electrically conductive rear contact pads 360 are disposed on one or both of the upper and lower surfaces 310, 320 at the inner end 340. The rear contact pads 360 are electrically connected, or coupled, to the front conductive contact pads 350, e.g., through conductive traces located on and/or through the circuit board 202 or 204, through one or more wires extending along the circuit board, etc. For the rear circuit boards 212 and 214, electrically conductive rear contact pads 350′ are disposed on one or both of the upper and lower surfaces 310′, 320′ at the cable end 330′ of the rear circuit board 212 or 214. The electrically conductive contact pads 350′ are configured to be coupled to a shielded cable 2. Further, electrically conductive front contact pads 360′ are disposed on one or both of the upper and lower surfaces 310′, 320′ at the inner end 340′. The front contact pads 360′ are electrically connected, or coupled, to the rear conductive contact pads 350′, e.g., through conductive traces located on and/or through the circuit board 212 or 214, through one or more wires extending along the circuit board, etc.

In the depicted embodiment of FIG. 3, the rear circuit board 212 or 214 is coupled to the shielded cable 2 to form respective circuit board cable assemblies 200. As shown in FIG. 3, the circuit board cable assemblies 200 may be vertically spaced apart from one another. As used herein, “vertically spaced apart” may mean that the circuit board cable assemblies 200 may be separated by space in a thickness direction (e.g., substantially parallel to the z-axis) thereof.

Each of the circuit boards 202, 204, 212, and 214 can be a rigid circuit board, for example, a rigid printed circuit board (PCB). Additionally, each circuit board (e.g., 202, 204, 212, and 214) may be arranged such that the planes thereof may be parallel to each other, as shown in FIGS. 2 and 3.

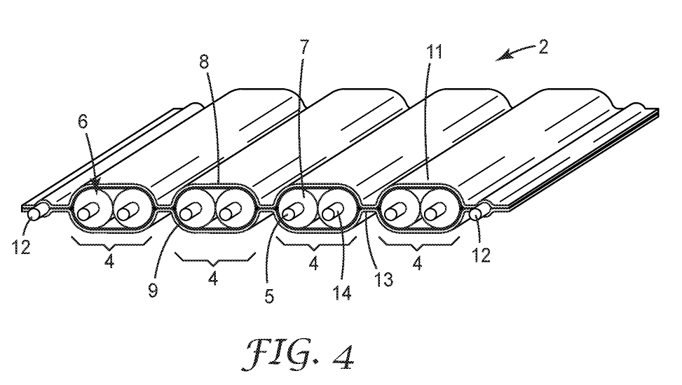

The exemplary shielded cable 2 for use with the circuit board cable assembly 200 is depicted in FIG. 4. The shielded cable 2 may include a plurality of conductor sets 4 and conductive shielding films 8, 9 disposed, or located, on either side of the shielded cable 2. Although the shielded cable 2 as shown includes 2 shielding films 8, 9, it is to be contemplated that the conductor sets 4 may be encapsulated, or wrapped, with a single shielding film, or more than two shielding films.

Each of the conductor sets 4 may extend along a length of the shielded cable 2 (e.g., from a first end region to a second end region) and may include two or more insulated conductors 6. Each insulated conductor 6 may include a central conductor 5 surrounded by, or wrapped in, a dielectric material 7. The central conductor 5, as self-described, may include conductive material such as, e.g., copper, aluminum, etc. Likewise, the dielectric material 7 may include one or more dielectric, or nonconductive, materials such, e.g., one or more polymers.

The first and second conductive shielding films 8, 9 may include, or form, cover portions 11 and pinched portions 13 along the shielded cable 2. The cover portions 11 and the pinched portions 13 may be arranged such that, in a transverse cross section as partially shown in the perspective end view in FIG. 4, the cover portions 11 of the first and second shielding films 8, 9 in combination substantially surround each conductor set 4, and the pinched portions 13 of the first and second shielding films 8, 9 in combination form pinched portions 13 of the shielded cable 2 on each side of each conductor set 4. In other words, the first and second shielding films 8, 9 form cover portions 11 that extend around each conductor set 4 and pinched portions 13 between each conductor set 4. The cover portions 11 and the pinched portions 13 may be formed by locating the first shielding film 8 above the conductor sets 4 and the second shielding film 9 below the conductors set 4 and coupling (e.g., bonding, thermo-welding, adhering, etc.) the shielding films 8, 9 to form the pinched portions 13, and in turn, form the cover portions 11.

The shielded cable 2 may further include ground conductors 12 extending along a length of the shielded cable 2. The ground conductors 12 may be electrically coupled to the first and second shielding films 8, 9 (e.g., pinched between each of the first and second shielding films 8, 9) to, e.g., provide electromagnetic shielding for the conductor sets 4. Additionally, the outside of the shielded cable 2 may be insulated from the environment, such as, e.g., any object (e.g., one or more components located within a server case) or any user that may touch the shielded cable 2. To insulate the shielded cable 2 (or more particularly, the first and second shielding films 8, 9) from the environment, the first and second shielding films 8, 9 may be coated in, or surrounded by, one or more dielectric materials such as, e.g., one or more polymers, etc.

As shown, the dielectric material 7 and the conductive shielding 8, 9 disposed on opposed first and second sides of the shielded cable 2 may leave exposed ends 14 of the central conductors 5 exposed to allow conductive coupling, or attachment, of the central conductors 5 to conductive elements such as the conductive pads 350′ of the rear circuit board 212.

Suitable shielded cables for use with the circuit board cable assembly 200 are also described in, for example, WO2010/148157 (attorney docket No. 65542WO003), WO2010/148161 (attorney docket No. 65542WO010), WO2010/148164 (attorney docket No. 65542WO014), and WO2010/148165 (attorney docket No. 65542WO020), which are incorporated herein by reference.

Referring again to FIG. 3, one or more flexible, electrically conductive traces 410 are positioned to electrically connect the rear contact pads 360 of the front circuit board 202 or 204 and the front contact pads 360′ of the rear circuit board 212 or 214. In some embodiments, the flexible electrically conductive traces 410 can be disposed on a flexible substrate to form a flexible circuit board. The flexible substrate can extend between and attached to the front and rear circuit boards. The flexible substrate can include flexible plastic substrates including, for example, polymide, polyester, etc. The flexible circuit board can be single sided, double sided, or multilayered. In the depicted embodiment of FIGS. 2 and 3, the flexible electrically conductive traces or circuits 410 extend between the front and rear circuit boards with a suitable length and flexibility that allows a twist of the flexible circuit 410 when the rear circuit board is rotated with respect to the front circuit board.

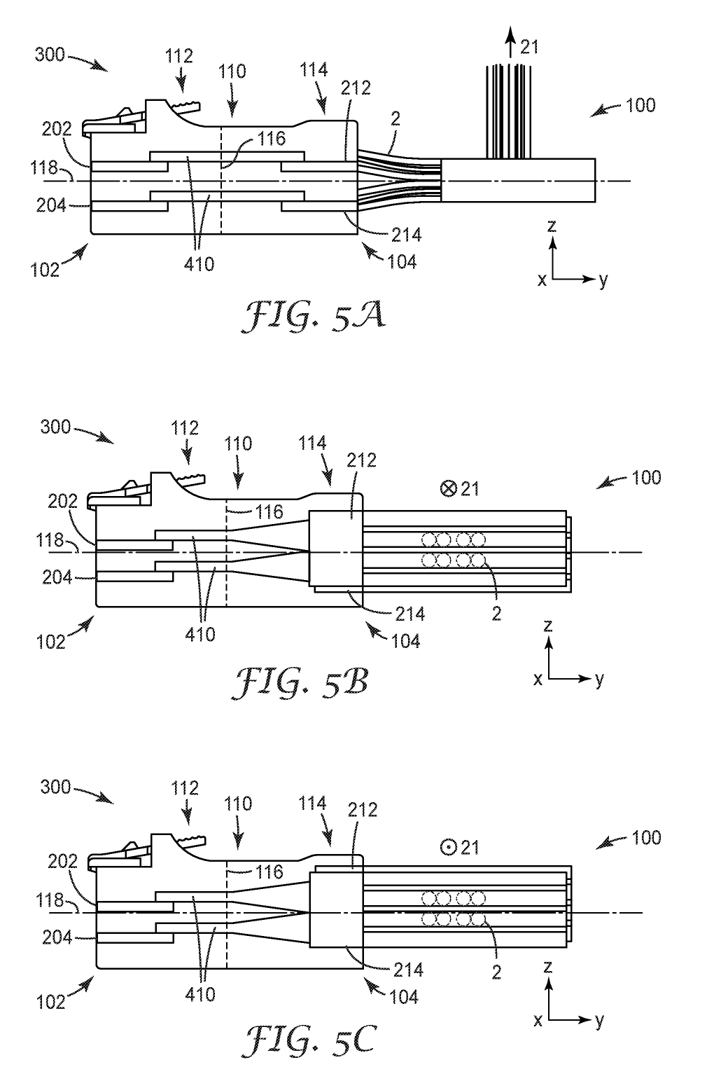

The flexible, electrically conductive traces 410 are capable of twisting when the rear housing portion 114 rotates about a rotational axis relative to the front housing portion 112. FIGS. 5A-C illustrate a process of rotating the rear housing portion 114 of a connector 300 to change the relative orientation of the front circuit board 202 or 204 and the rear circuit board 212 or 214, and change the exit direction of the cable 2. The exemplary connector 300 has an array of front terminals at a mating end 102 that are configured to engage a mating connector (not shown) along a mating direction substantially parallel to the rotational axis (e.g., the y-axis). The connector 300 further includes an array of rear terminals at a cable end 104 configured to make electrical contact with conductors of the cable 2 received within the connector 300. The front and rear terminals of the connector 300 are rotatable with respect to each other about a rotational axis 118 that is substantially parallel to the mating direction. In some embodiments, the rotational axis 118 can be a central axis of the connector housing 110.

In some embodiments, the front terminals of the connector 300 may be located on a front circuit board such as, for example, the front circuit board 202 of FIG. 3, and the rear terminals may be located on a rear circuit board such as, for example, the rear circuit board 212 of FIG. 3. In some embodiments, the front and rear terminals may be located on opposite ends of a single flex-rigid circuit board that may be a combination of flexible and rigid board portions. The flexible portion of the flex-rigid circuit board can be in a constant state of flex, and is capable of forming into a flexed curve and twisting when the front and rear terminals are rotated about a rotational axis with respect to each other.

In the depicted embodiment of FIGS. 5A-C, the connector 300 and the coupled cable 2 form the connector assembly 100 that is a right-angled connector. The cable 2 is connected to the rear circuit boards 212 and 214 at the cable end 104 and extends along an exit direction 21 substantially perpendicular to the rotational axis 118. It is to be understood that connector assembly 100 may be other types of connectors where the cable 2 ca exit along other directions.

FIG. 5A shows the configuration of the connector assembly 100 before the relative rotation of the front and rear housing portions 112 and 114. The front circuit board (e.g., 202 and 204) and the rear circuit board (e.g., 212 and 214) are oriented with the respective planes to be substantially parallel to each other (e.g., substantially parallel to the x-y plane). The cable 2 is connected to the rear circuit boards 212 and 214 at the cable end 104 and exits along the exit direction 21 substantially parallel to the z-axis.

When the rear housing portion 114 is rotated about the rotational axis 118 with respect to the front housing portion 112 for about +90 degrees, the rear circuit board (e.g., 212 and 214) and the coupled cable 2 can also rotate along with the rear housing portion 114, which changes the relative orientation of the front and rear circuit boards to be substantially perpendicular to each other, and change the exit direction 21 of the cable 2 to be substantially parallel to the −x direction (into the plane of the page), as shown in FIG. 5B. When the rear housing portion 114 is rotated about the rotational axis for about −90 degrees, the rear circuit board (e.g., 212 and 214) and the coupled cable 2 can also rotate along with the rear housing portion 114, which changes the relative orientation of the front and rear circuit boards to be substantially perpendicular to each other, and changes the exit direction 21 of the cable 2 to be substantially parallel to the +x direction (out of the plane of the page), as shown in FIG. 5C. In the depicted embodiment, the rotation of the rear housing portion 114 with respect to the front housing portion 112 can provide an adjusting angle in the range of about −90 degrees to about 90 degrees for the cable exit direction 21. It is to be understood that variable adjusting angles in a range of about −180 degrees to about 180 degrees can be provided according to the specific applications.

During the rotation of the rear housing portion 114 with respect to the front housing portion 112, the flexible electrically conductive traces or flexible circuit 410 can twist about the rotational axis 118 at the same time, as shown in FIGS. 5B-C. The originally vertically spaced flexible circuits 410 may be in contact to each other during the rotation. Suitable insulative mechanisms may be applied to prevent possible short circuit issues. In some embodiments, the opposing surfaces of the vertically spaced flexible circuit 410 may be provided with an insulative protective layer.

In some embodiments, the exemplary connector assembly 100 may further include an overmold located around the one or more circuit board cable assemblies 200. The overmold may be molded around, or about, at least a portion of the circuit board cable assemblies 200. In at least one embodiment, the overmold may be formed by locating the circuit board cable assemblies 200 within a two-piece mold, injecting overmold material in a fluid state into the two-piece mold, and allowing the overmold material to cure around the circuit board cable assemblies 200. In other words, the overmold may be “injection” molded. An exemplary overmold was described in WO 2014/099331 (Lee and Bandhu, attorney docket No. 71299WO003), which is incorporated herein by reference.

The connector assembly 100 may further include additional elements or features that may be used to couple the connector assembly 100 to a female interface, or connector. For example, as shown in FIG. 1, the connector assembly may further include a latching member 500, e.g., configured to latch to a portion of a female interface to removably coupled the connector assembly to the female interface. The latching member 500 includes a resilient arm 510 making an oblique angle θ with the front housing portion 112. The oblique angle θ may be greater than about 3 degrees and less than about 45 degrees. In at least one embodiment, the oblique angle θ may be about 10 to about 15 degrees. The resilient arm 510 includes a fixed end 520 attached to the upper housing half 120a, an opposite free end 530, and a latch 540 disposed between the fixed and free ends 520, 530. The latch 540 is a protrusion extending from the surface of the resilient arm 510 that is configured to engage, or latch, within a portion (e.g., an aperture) of a female interface. The resilient arm 510 may be configured to deflect, or move, by applying force to the resilient arm 510 such that the latch 540 may be engaged or disengaged with a portion of the female interface. Further, the resilient arm 510 may be biased to position the latch 540 to engage a portion of a female interface, and a user may have to apply a force to the resilient arm 510 (e.g., to the free end 530) to disengage the connector assembly 100 from the female interface. In at least one embodiment, the fixed end 520 may be removably attached to the upper housing half 120a such that, e.g., the latching member 500 may be removed from the housing 110 if not needed.

The exemplary connector assembly 100 described herein may be configured to be used in multiple different high-speed signal protocols such as, e.g., MiniSAS HD, etc. As shown, the connector assembly 100 may conform to SFF 8643, an integrated connector receptacle specification, developed by and available from the Small Form Factor (SFF) committee.

The exemplary connector assembly 100 may provide low impedance across its electrical connections to conform to various industry standards. For example, an impedance measured between a conductive pad of the rear conductive pads 350′ of the rear circuit board 212 and a corresponding central conductor 5 of the insulated conductors 6 of the shielded cables 2 may be less than or equal to 115 ohms, less than or equal to 110 ohms, less than or equal to 105 ohms, less than or equal to 100 ohms, etc.

### Listing of Exemplary Embodiments

The following are a list of embodiments of the present disclosure. It is to be understood that any one of embodiments 1-12, 13, and 14-21 can be combined. Embodiment 1 is a connector, comprising:
a first front circuit board disposed within a front housing portion;
a first rear circuit board disposed within a rear housing portion assembled to the front housing portion, each of the first front and rear circuit boards comprising:
a plurality of front contact pads disposed near a front edge of the circuit board; and
a plurality of rear contact pads disposed behind and in electrical communication with the front contact pads, the front contact pads of the first front circuit board configured to engage corresponding terminals of a mating connector, the rear contact pads of the first rear circuit board configured to make electrical contact with conductors of a cable; and
a first plurality of flexible electrically conductive traces providing electrical communication between the rear contact pads of the first front circuit board and the front contact pads of the first rear circuit board, the rear housing portion rotatable about a rotational axis relative to the front housing portion to change a relative orientation of the first front and rear circuit boards.

Embodiment 2 is the connector of embodiment 1, wherein each of the front and rear housing portions comprises an upper housing portion assembled to a lower housing portion.

Embodiment 3 is the connector of embodiment 1 or 2 further comprising a flexible substrate extending between and attached to the first front and rear circuit boards, the first plurality of flexible electrically conductive traces being formed on the flexible substrate.

Embodiment 4 is the connector of any one of embodiments 1-3 being a right-angled connector.

Embodiment 5 is the connector of any one of embodiments 1-4, wherein the first plurality of flexible electrically conductive traces twist when the rear housing portion rotates relative to the front housing portion.

Embodiment 6 is the connector of any one of embodiments 1-5, wherein the rear housing portion is rotatable in an angular range from about −90 degrees to about 90 degrees.

Embodiment 7 is the connector of any one of embodiments 1-6, wherein the front and rear housing portions are electrically insulative.

Embodiment 8 is the connector of any one of embodiments 1-7 further comprising a latching member disposed on the front housing portion, the latching member comprising a resilient arm making an oblique angle with a top surface of the front housing portion.

Embodiment 9 is the connector of any one of embodiments 1-8, wherein the connector conforms to SFF 8643.

Embodiment 10 is the connector of any one of embodiments 1-9 further comprising:
a second front circuit board disposed within the front housing portion below the first front circuit board;
a second rear circuit board disposed within the rear housing portion below the first rear circuit board; and
a second plurality of flexible electrically conductive traces providing electrical communication between the second front and rear circuit boards.

Embodiment 11 is the connector of any one of embodiments 1-10, wherein the rotational axis is substantially parallel to a mating direction of the connector.

Embodiment 12 is the connector of any one of embodiments 1-11, wherein each of the first front and rear circuit boards is rigid.

Embodiment 13 is a connector assembly comprising:
a cable comprising a plurality of conductors; and
the connector of any one of the preceding embodiments, the plurality of conductors making electrical contact with the plurality of rear contact pads of the first rear circuit board.

Embodiment 14 is a connector for mating with a mating connector along a mating direction and comprising:
a plurality of front terminals for making electrical contact with a corresponding plurality of terminals of a mating connector; and
a plurality of rear terminals for making electrical contact with conductors of a cable received within the connector, the rear terminals rotatable relative to the front terminals about a rotational axis substantially parallel to the mating direction.

Embodiment 15 is the connector of embodiment 14 further comprising a flexible circuit board disposed within the connector and electrically connecting the front terminals to the rear terminals, such that the flexible circuit board twists when the rear terminals rotate relative to the front terminals.

Embodiment 16 is the connector of embodiment 14 or 15 further comprising:
a first front circuit board disposed within a front housing portion, the first front circuit board including the plurality of front terminals; and
a first rear circuit board disposed within a rear housing portion assembled to the front housing portion, the first rear circuit board including the plurality of rear terminals.

Embodiment 17 is the connector of embodiment 16, wherein each of the front and rear housing portions comprises an upper housing portion assembled to a lower housing portion.

Embodiment 18 is the connector of embodiment 16 or 17, wherein the flexible circuit board extends between and attached to the first front and rear circuit boards.

Embodiment 19 is the connector of any one of embodiments 14-17 being a right-angled connector.

Embodiment 20 is the connector of any one of embodiments 16-19, wherein the flexible circuit board twist when the rear housing portion rotates relative to the front housing portion.

Embodiment 21 is the connector of any one of embodiments 16-20, wherein the rear housing portion is rotatable in an angular range from about −90 degrees to about 90 degrees.

Thus, embodiments of ROTATABLE CONNECTOR ASSEMBLY are disclosed. One skilled in the art will appreciate that the compositions described herein can be practiced with embodiments other than those disclosed. The disclosed embodiments are presented for purposes of illustration and not limitation.

1. A connector, comprising:
a first front circuit board disposed within a front housing portion;
a first rear circuit board disposed within a rear housing portion assembled to the front housing portion,
each of the first front and rear circuit boards comprising:
a plurality of front contact pads disposed near a front edge of the circuit board; and
a plurality of rear contact pads disposed behind and in electrical communication with the front contact pads,
the front contact pads of the first front circuit board configured to engage corresponding terminals of a mating connector, the rear contact pads of the first rear circuit board configured to make electrical contact with conductors of a cable; and
a first plurality of flexible electrically conductive traces providing electrical communication between the rear contact pads of the first front circuit board and the front contact pads of the first rear circuit board,
wherein the rear housing portion is rotatable about a rotational axis relative to the front housing portion to change a relative orientation of the first front and rear circuit boards.

2. The connector of claim 1, wherein each of the front and rear housing portions comprise an upper housing portion assembled to a lower housing portion.

3. The connector of claim 1 further comprising a flexible substrate extending between and attached to the first front and rear circuit boards, the first plurality of flexible electrically conductive traces formed on the flexible substrate.

4. The connector of claim 1 being a right-angled connector.

5. The connector of claim 1, wherein the first plurality of flexible electrically conductive traces twist when the rear housing portion rotates relative to the front housing portion.

6. The connector of claim 1, wherein the rear housing portion is rotatable in an angular range from about −90 to 90 degrees.

7. The connector of claim 1, wherein the front and rear housing portions are electrically insulative.

8. The connector of claim 1 further comprising a latching member disposed on the front housing portion, the latching member comprising a resilient arm making an oblique angle with a top surface of the front housing portion.

9. The connector of claim 1, wherein the connector conforms to SFF 8643.

10. The connector of claim 1 further comprising:
a second front circuit board disposed within the front housing portion below the first front circuit board;
a second rear circuit board disposed within the rear housing portion below the first rear circuit board; and
a second plurality of flexible electrically conductive traces providing electrical communication between the second front and rear circuit boards.

11. The connector of claim 1, wherein the rotational axis is substantially parallel to a mating direction of the connector.

12. The connector of claim 1, wherein each of the first front and rear circuit boards is rigid.

13. A connector assembly comprising:
a cable comprising a plurality of conductors; and
the connector of claim 1, the plurality of conductors making electrical contact with the plurality of rear contact pads of the first rear circuit board.

14. A connector for mating with a mating connector along a mating direction and comprising:
a plurality of front terminals for making electrical contact with a corresponding plurality of terminals of a mating connector; and
a plurality of rear terminals for making electrical contact with conductors of a cable received within the connector, the rear terminals rotatable relative to the front terminals about a rotational axis substantially parallel to the mating direction.

15. The connector of claim 14 further comprising a flexible circuit board disposed within the connector and electrically connecting the front terminals to the rear terminals, such that the flexible circuit board twists when the rear terminals rotate relative to the front terminals.
